(19) United States
(12) Patent Application Publication
(10) Pub. No.: US 2011/0017071 A1
(43) Pub. Date: Jan. 27, 2011

(54) MACHINE FOR DISPENSING INFUSIONS FROM A POD PREPARATION HAVING A RESETTING DEVICE

(75) Inventor: Roberto Stefanoni, Oggiono (IT)

Correspondence Address: Steinfl & Bruno, 301 N Lake Ave Ste 810, Pasadena, CA, 91101, US

(73) Assignee: IDES LTD, San Po Kong, Kowloon (HK)

(21) Appl. No.: 12/865,677

(22) PCT Filed: Feb. 18, 2009
(86) PCT No.: PCT/IB2009/000284

§ 371 Date: Jul. 30, 2010

(30) Foreign Application Priority Data
Feb. 18, 2008 (IT) RM2008A000092

(51) Int. Cl. A47J 31/54; A47J 31/44

(52) U.S. Cl. 99/288; 99/295

(57) ABSTRACT

A machine 1 for dispensing infusions, such as coffee, tea and the like from a pod/cartridge (C) preparation and the like, comprising: an infusion head unit 2 for heating and dispensing a fluid that transits through the cartridge (C) for dispensing the infusion; a housing 3 for the cartridge (C), such as to assume a first ‘set’ configuration of loading the cartridge (C) and extracting the infusion and a second ‘unset’ configuration of ejecting the cartridge (C); and moving means 4 of said infusion head unit 2 and/or of said housing 3, apt to control a step of dispensing the infusion and a subsequent step of ejecting and resetting (FIG. 1).

The present invention refers to a machine for dispensing infusions, such as coffee, tea, etc. from a cartridge/pod preparation.

In particular, it refers to an infusion machine of the type comprising an automatic cartridge ejection system.

Several types of machines are known on the market for preparing infusions such as coffee, tea and the like from a generally granular preparation contained in cartridges, pods and the like.

Such machines typically comprise a boiler where a fluid, generally water, is heated and brought to pressure, and a pod holder that can be fitted to the boiler for extracting the infusion.

In particular, infusion machines envisage a user's placing a new pod in the pod holder and connecting the latter to the boiler. Then, boiler-dispensed fluid under pressure passes through the pod and the infusion made (brewed) is extracted from the bottom of the pod holder. At the end of the infusion extracting step, the used pod has to be removed, so as to allow a new use of the machine.

The machines for preparing infusions from a product contained in a cartridge as those described above typically envisage that a user, in order to process an infusion from a single-dose cartridge/pod and prearrange the machine for a subsequent use, has to carry out the following steps:
1. inserting the cartridge in the cartridge holder;
2. bringing back the cartridge holder under the boiler;
3. dispensing the infusion;
4. ejecting the cartridge;
5. “resetting” the cartridge holder, i.e. bringing it back into a configuration in which it is ready to receive a new cartridge; and
6. extracting the cartridge holder from under the boiler.

Generally the above-mentioned steps are elaborate and require the use of complex devices.

In some machines, envisaging a stationary pod holder under the boiler, steps 2 and 6 are unnecessary; however, the user anyhow has to carry out the remaining four steps, requiring execution times that depend on the machine type, and anyhow are relatively lengthy.

The technical problem underlying the present invention is to provide a machine for dispensing infusions allowing to overcome the drawbacks mentioned above with reference to the known art.

Such a problem is solved by a machine for dispensing infusions according to claim 1.

Preferred features of the present invention are set forth in the dependent claims thereof.

The present invention provides several relevant advantages. The main advantage of the present invention is to provide a machine for dispensing infusions that allows to eject the cartridge and “reset” the cartridge holder substantially in a single step, continuous, quick and carried out automatically. Therefore, the present invention allows to reduce the number of steps to be carried out and the times required between an infusion dispensing and the subsequent one.

A further advantage of the present invention is to provide an extremely simple and safe machine, allowing to insert the cartridge, dispense the infusion and eject the cartridge without ever coming into contact with the cartridge holder.

It will be understood that in the present document by the term “cartridge” there will be meant without distinction cartridges, pods and the like.

Advantages, features and the operation steps of the present invention will be made apparent in the following detailed description of an embodiment thereof, given by way of example and not for limitative purposes. Reference will be made to the figures of the annexed drawings, wherein:

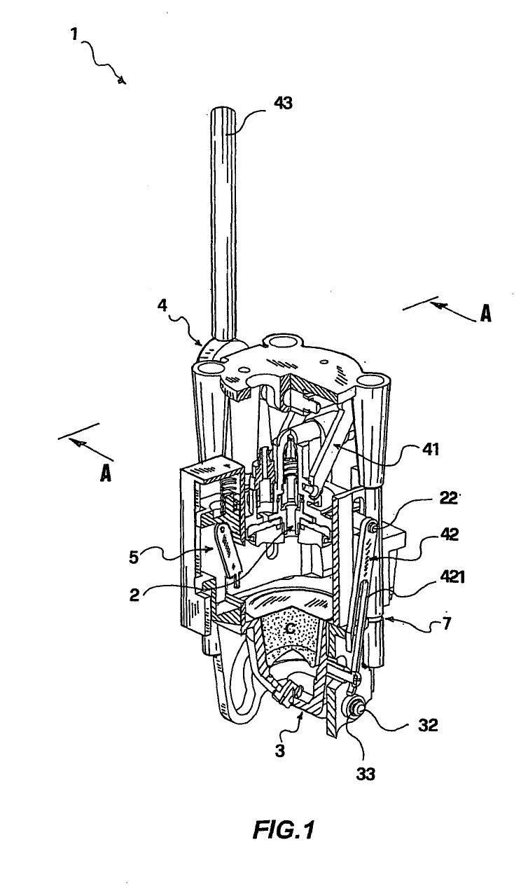

FIG. 1 shows a top perspective view in partial section of the infusion machine according to a preferred embodiment of the present invention;

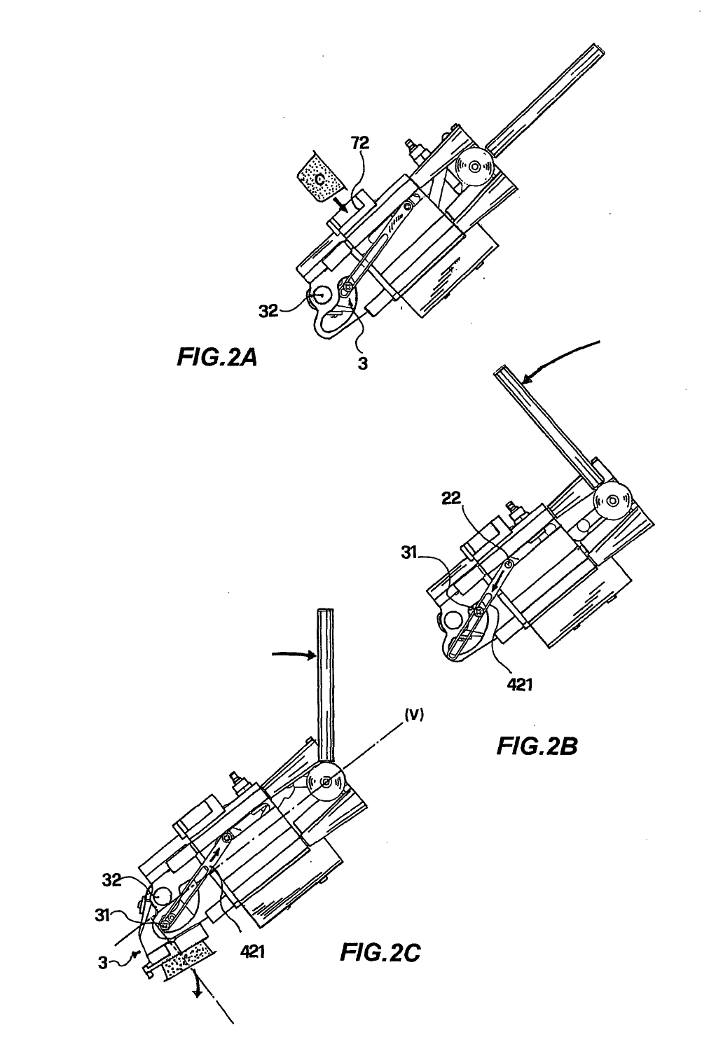

FIGS. 2A, 2B and 2C each show a side view of the machine of FIG. 1 in a first embodiment in which said machine is mounted at 45° with respect to the ground, respectively in a first step of loading the cartridge, in a second step of dispensing the infusion and in a third step of ejecting the cartridge;

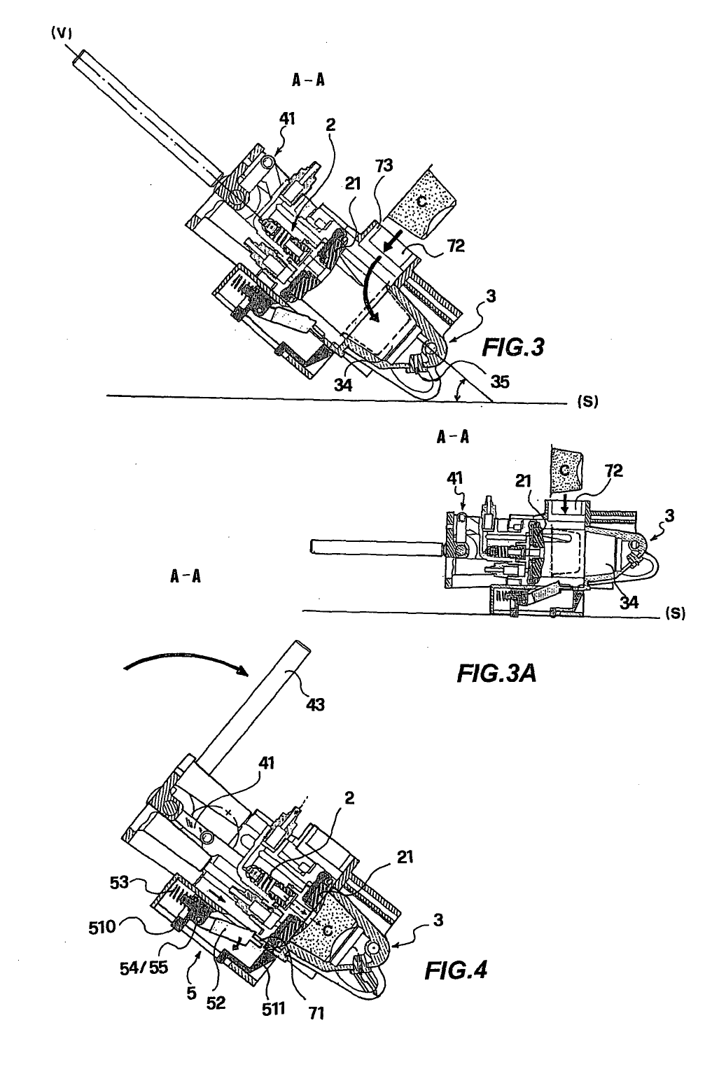

FIGS. 3 and 3A each show a cross-sectional view of the machine of FIG. 1 in a first cartridge loading step, in said first embodiment in which the infusion machine is mounted at 45° with respect to the ground (S) and in a second embodiment in which the infusion machine is mounted parallelly to the ground (S), respectively;

FIGS. 4, 5, and 6 each show a cross-sectional view of the infusion machine of FIG. 2, in the second infusion dispensing step, the third cartridge ejecting step and a fourth “resetting” step, respectively;

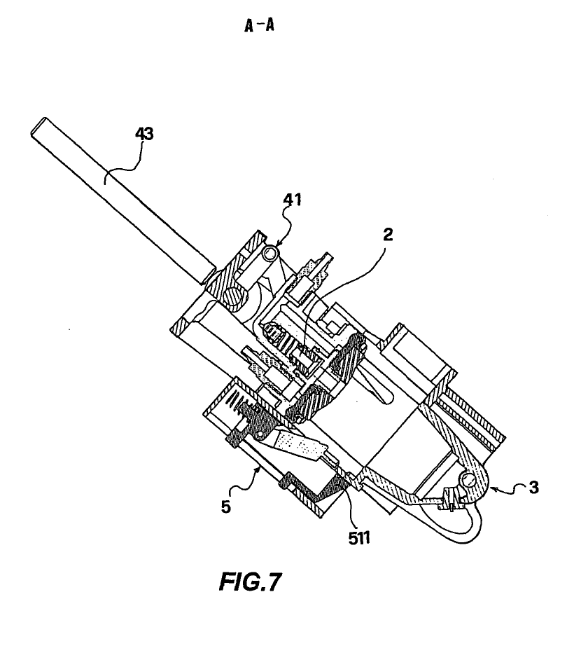

FIG. 7 shows a cross-sectional view of the infusion machine of FIG. 2 “reset” and ready to receive a new cartridge.

Referring to FIG. 1, a machine for dispensing infusions such as coffee, tea and the like from a preparation in a cartridge C is generally denoted by 1.

The machine 1 for dispensing infusions mainly comprises: an infusion head unit 2 for heating and dispensing a fluid that transits through the cartridge C for dispensing the infusion; a housing 3 for the cartridge C; means 4 for actuating the infusion head unit 2 and/or the housing 3; and means 5 for blocking and/or supporting the housing 3. As it is shown always in FIG. 1, the infusion head unit 2, the housing 3 and the actuating means 4 are associated to a frame 7.

Structure and function of the hereto-introduced components will presently be detailed.

As it is shown, e.g., in the sequence of FIGS. 2A, 2B and 2C, the housing 3 can assume a first “set” configuration of loading the cartridge C and extracting the infusion (FIGS. 2A, 2B) and a second “unset” configuration of ejecting the cartridge C (FIG. 2C). As it will be detailed hereinafter, in the first “set” configuration of loading the cartridge C and extracting the infusion, the means 5 for blocking and/or supporting the housing 3 support at least one free transverse end of the housing 3.

In particular, in the present embodiment the housing 3 is rotatably connected, at a bottom portion thereof, to the frame 7 through rotatable connection means, e.g. a pin 32. Said rotatable connection means 32 can envisage an opposing element 33, associated e.g. to the pin 32 or the seat thereof, its function being that of fostering the rotation of the housing 3 in the change from said first “set” configuration of loading the cartridge C and extracting the infusion to said second “unset” configuration of ejecting the cartridge C. The opposing element 33 may be, for instance, a torsion spring. According to a preferred embodiment, rotation of the housing 3 occurs about an axis defined by the above-mentioned pin and lying on a substantially horizontal pin.

As shown in FIG. 3, the housing 3 envisages a seat 34, shaped so as to receive the cartridge C and limited bottomwise by a filter apt to allow transit of the infusion to an outlet port 35 of the infusion itself.

As shown in FIG. 1, the infusion head unit 2 comprises a cartridge-pressure element 21 that, as it will be detailed hereinafter, has the function of exerting a predetermined pressure on the cartridge during the infusion dispensing step.

It will be understood that according to alternative embodiments the infusion machine 1 could provide infusion head units 2 different from the one described hereto.

As shown in FIG. 3, the infusion head unit 2 and said housing 3 are arranged longitudinally aligned along an axis V.

According to the present embodiment, the infusion head unit 2 is slidably mounted on the frame 7 so as to assume a first position adjoining the housing 3 in which it is lowered (FIG. 4) and a second spaced-apart position from the housing 3 in which it is lifted (FIG. 3). As shown, e.g., from the sequence of FIGS. 3 and 4, the infusion head unit 2 slides internally to the frame 7 along said longitudinal axis V. Evidently, according to alternative embodiments, the infusion head unit 2 may be stationary, therefore integral to the frame 7, whereas the housing 3 may be slidably mounted in said frame 7 so as to assume a first position adjoining the infusion head unit 2, in which the housing 3 is lifted, and a second spaced-apart position from the infusion head unit 2, in which the housing 3 is lowered.

According to the present embodiment, the means 5 for blocking and/or supporting the housing 3 is connected to the frame 7 and, as mentioned hereto, apt to support at least one free transverse end of the housing 3 when the latter lies in said first “set” configuration of loading the cartridge C and extracting the infusion. In particular, the means 5 for blocking and/or supporting the housing 3 is snap-locking means apt to disengage from said free end when, as it will be evident hereinafter, said infusion head unit 2 changes from said first position adjoining the housing 3, in which it is lowered, to said second spaced-apart position from the housing 3, in which it is lifted.

As shown, e.g., in FIG. 4, in a preferred embodiment the means 5 for blocking and/or supporting the housing 3 comprises:
a main bolt 51, having a top portion 510 and a bottom portion 511 integral therebetween;
a secondary bolt 52, rotatably connected to the top portion 510 of the main bolt 51; and
elastic opposing means 53.

The rotatable connection between the main bolt 51 and the secondary bolt 52 is made through suitable rotatable connection means 54, comprising an opposing element 55, which “push” the free portion of the secondary bolt toward an opening 71 of the frame 7 facing the housing 3.

As shown in FIGS. 1 and 3, the means 4 for actuating said infusion head unit 2 and/or said housing 3 comprises:
first means 41 for moving said infusion head unit 2 (FIG. 2); and
second means 42 for moving said housing 3 (FIG. 1).

In particular, the first moving means 41 is moving and opposing means 41 integral to said infusion head unit 2 and such as to block the latter in its first close position (FIG. 4).

In a preferred embodiment the first moving means 41 comprises a so-called “toggle-type” moving system based on a pair of hinged levers, as shown in FIG. 3. When the infusion head unit 2 is in the second spaced-apart position from the housing 3, in which it is lifted, the toggle-type moving system is retracted (i.e., said levers form a generally acute angle, as shown in FIG. 3), whereas when the infusion head unit 2 is in the first position adjoining the housing 3, in which it is lowered, the toggle-type moving system 41 is extended (i.e., said levers are substantially aligned, as shown in FIG. 4). In this latter position the toggle-type moving system 41 makes a safety blocking of the infusion head unit 2, by overstepping its own end of stroke in a reverse-angle configuration.

The second moving means 42 is connected to the housing 3 and integral to the infusion head unit 2, as shown in FIG. 1.

In a preferred embodiment, such second moving means 42 comprises at least one connecting rod 421 connected, at a first end thereof, to said infusion head unit 2 and, at a second end thereof, to said housing 3.

As it will be evident from the description of operation of the infusion machine 1, the connecting rod 421 follows the infusion head unit 2 in its change from the position adjoining the housing 3 to the spaced-apart position from the housing 3, thereby allowing the changing of the housing 3 from said “unset” configuration to said “set” configuration.

As shown in FIG. 2B, the connecting rod 421 is connected to the infusion head unit 2 by respective rotatable connection means 22. The connection between the connecting rod 421 and the housing 3 is made through a slot obtained in the connecting rod 421 for engagement with a respective pin, or shoe, 31 integral to the housing 3.

In the present embodiment, the actuating means 4 comprises a control lever 43 for controlling said first moving means 41 of said infusion head unit 2 and said second moving means 42 of said housing 3.

As shown in detail in FIGS. 2A and 3, the frame 7 provides a “mouth” 72 for inserting the cartridge C at or directly into the cartridge holder 3.

In particular, according to the present embodiment, the cartridge C, once inserted into the “mouth” 72, is slidably coupled to insertion guides 73, apt to direct the cartridge to the cartridge holder 3.

Operation of the infusion machine 1 described hereto will be made apparent from the following description of the related process of use.

In particular, operation will presently be described with reference to an infusion machine 1 mounted tilted of 45° with respect to the ground (S in FIG. 3).

Step 1: Inserting the Cartridge into the Cartridge Holder

Referring initially to FIG. 7, the infusion machine 1 lies in a first configuration ready for use by a user, in which:
the lever 43 is lifted;
the first moving means 41 of said infusion head unit 2 is retracted;
the infusion head unit 2 is in said second spaced-apart position from the housing 3;
the housing 3 is in said first “set” configuration of loading the cartridge C; and
the means 5 for blocking and/or supporting, through the bottom portion 511 thereof, support and block the housing 3 in said first “set” configuration.

Referring to FIGS. 2A and 3, a cartridge C is inserted into the housing 3 through the “mouth” 72 of the frame 7 and the insertion guides 73.

It will be appreciated that, according to the present embodiment in which the infusion machine 1 is mounted tilted with respect to the ground (S), the cartridge C positions itself in the housing 3 by effect of gravity.

In a configuration different from the preceding one in which the infusion machine 1 is mounted horizontal with respect to the ground, as shown in FIG. 3A, the cartridge C, inserted through the “mouth” 72, remains inside the frame 7, resting on the secondary bolt 52 and being held in position (at the seat 34 of the housing 3) by the insertion guides 73. In this case, as it will be made apparent hereinafter, the cartridge C is inserted into the related seat 34 only when the infusion head unit 2 is brought in the first position adjoining the housing 3.

### Step 2: Dispensing the Infusion

Turning to the present example, once the cartridge C is inserted into the housing 3, the moving means 41 of said infusion head unit 2, in this case the toggle-type moving system, actuates, lowering the lever 43

As shown in FIG. 4, when the lever 43 has reached its lowered position, the infusion machine 1 lies in a configuration apt to dispense the infusion, wherein:
the infusion head unit 2 is in said first position adjoining said housing 3;
the toggle-type moving system 41 is extended and makes a safety blocking of the infusion head unit 2, by overstepping its own end of stroke in a reverse-angle configuration; and
the housing 3 is still in the preceding “set” configuration of loading the cartridge C and extracting the infusion.

As shown in the sequence of FIGS. 2A and 2B, the second moving means 42 of the housing 3, being integral to the infusion head unit 2, are lowered with respect to the preceding configuration. In changing from Step 1 to Step 2, the second moving means 42 does not interfere with the housing 3 as the pin 31 connected to the housing 3 moves along the slot (FIG. 2A) obtained in the connecting rod 421, coming from a position abutting the bottom of the slot to a position substantially opposite to the latter (FIG. 2B).

Lastly, as is evident from the sequence of FIGS. 3 and 4, in this step the secondary bolt 52 rests against the infusion head unit 2 by means of the opposing element 55.

In this step, infusion dispensing occurs through the cartridge-pressure element 21 that presses, via a gasket thereof, on the cartridge holder 3 and the cartridge C.

### Step 3: Ejecting and “Resetting”

Upon ending infusion dispensing, the lever 43 can be lifted again.

In this step, ejecting of cartridge C and “resetting” of housing 3 occur.

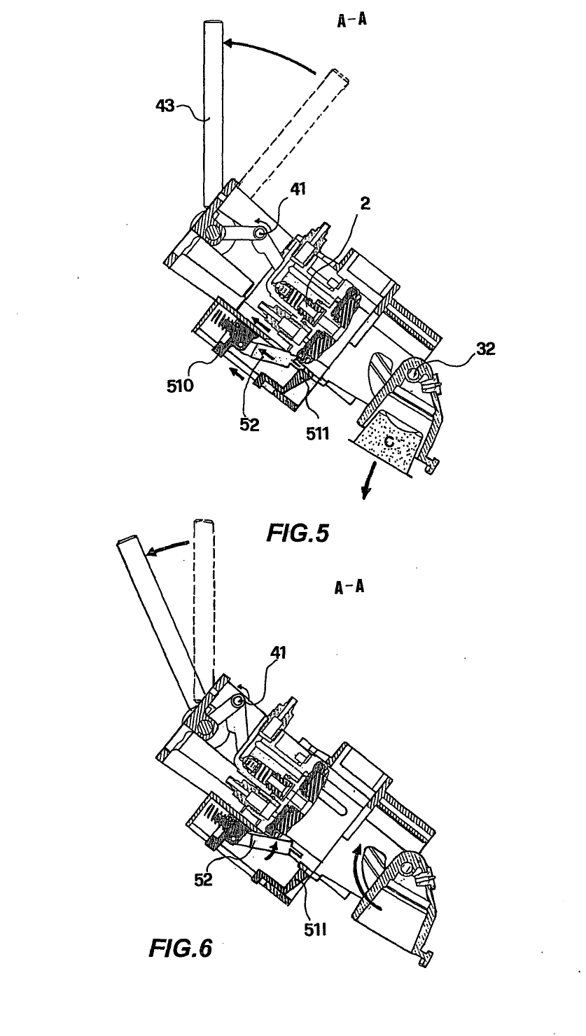

In particular, as shown in FIG. 5, the toggle-type moving system 41, actuated by the lever 43, lifts the infusion head unit 2 which in turn interferes with the secondary bolt 52, lifting it. As mentioned in the foregoing, the bolt 52 is connected to the top portion 510 of the main bolt that, through its bottom portion 511, blocks and supports the housing 3 in said “set” configuration of loading the cartridge C and extracting the infusion. Then, the secondary bolt 52 lifts the main bolt 51 which, therefore, “frees” the housing 3, allowing it to rotate about the axis of rotation defined by the rotatable connection means 32.

In the present embodiment, the rotation bringing the housing 3 in said second “unset” configuration of ejecting the cartridge C is effected by the combined action of the force of gravity and the opposing element 33. As a result of said rotation, ejecting of cartridge C is attained substantially by effect of the action of the gravitational force, with possible contribution of the centrifugal force.

As shown in FIGS. 2C, 5 and 6, ejecting of cartridge C occurs when the lever 43 is partially lifted and the infusion head unit 2 has not ended its stroke in order to come into said second spaced-apart position from said housing 3.

In particular, as shown in FIG. 2C, during the change from the first “set” configuration to the second “unset” configuration, the pin 31 connected to the housing 3 abuts the bottom of the slot obtained in the connecting rod 421.

Further stroke of the lever 43 and infusion head unit 2 causes:
breaking of the interference between the secondary bolt 52 and the infusion head unit 2 (FIG. 6); and
“resetting” of the housing 3 (FIG. 7).

In particular, as shown in FIGS. 5 and 6, the secondary bolt 52 during its upstroke meets a striker plane (defined by opening 71) that rotates it so as to break the interference with the infusion head unit 2. This occurs not before the “freeing” of the housing by the main bolt 51. In particular, the striker plane is defined by the top portion of the frame portion defining the opening 71.

Upon breaking the interference, the blocking and/or supporting means 5 are brought back, by the elastic opposing means 53, into the initial configuration in which it is apt to block and support the housing 3 (FIG. 6).

Concomitantly, as shown in FIGS. 2C and 6, the further stroke of the infusion head unit 2 “lifts” the connecting rod 421, and therewith the housing 3, through the pin 21 integral thereto that lies in abutment on the bottom of the slot obtained in the connecting rod itself. As shown in the sequence of FIGS. 6 and 7, at the end of the further stroke of the lever 43 and the infusion head unit 2, the housing 3 lies again in the first “set” configuration of loading the cartridge C and extracting the infusion.

From the description of operation of the infusion machine 1 it will be evident that:
the arrangement of the housing 3 is such as to allow said housing 3 to change passively, by effect of the sole gravity, from said first “set” configuration of loading the cartridge C and extracting the infusion to said second “unset” configuration of ejecting the cartridge C;
said infusion head unit 2 and said housing 3 are generally mutually movable so as to assume said first close position, in which they are in contact, and said spaced-apart position, in which they are spaced apart;
the machine 1 for dispensing infusions can be mounted tilted, of a predetermined angle with respect to the ground (S), and according to two preferred embodiments said angle is of 0° or of about 45°;
the housing 3, in said second “unset” configuration of ejecting the cartridge C, is rotated, about an axis lying on a substantially horizontal plane, of a predetermined angle α with respect to said first. “set” configuration of loading the cartridge C and extracting the infusion; said angle α is dependent upon the tilt of the infusion machine 1 with respect to the ground (S) and/or a related end-of-stroke abutment. In particular, the angle α is preferably equal to about 45° or it may range between 40° and 180°; between 45° and 90°.

It will be appreciated that the present invention may be used with cartridges of different type, like, e.g.: non self-sealing PP cartridges, thermoformed material cartridges, self-sealing cartridges, etc.

The present invention has been hereto described with reference to a preferred embodiment thereof. It is understood that other embodiments might exist, all falling within the concept of the same invention, and all comprised within the protective scope of the claims hereinafter.

1. A machine for dispensing infusions from a cartridge, comprising:
an infusion head unit, suitable for heating and dispensing a fluid that transits through the cartridge for dispensing the infusions;
a housing adapted to receive the cartridge to assume a first “set” configuration of loading the cartridge and extracting the infusion and a second “unset” configuration of ejecting the cartridge; and
a means for a combined moving of said infusion head unit and of said housing, adapted to change the housing from said “set” configuration to said “unset” configuration and vice versa, depending on motion of said infusion head unit.

2. The machine according to claim 1, wherein said infusion head unit and said housing are mutually movable in a first adjoining position, in which said infusion head unit and said housing are in contact, and a second spaced apart position, in which said infusion head unit and said housing are apart.

3. The machine according to claim 1, wherein said infusion head unit is movable along a longitudinal axis provide a first position adjoining said housing and a second position spaced apart from said housing.

4. The machine according to claim 1, wherein said infusion head unit and said housing are aligned longitudinally.

5. The machine according to claim 1, wherein said housing is rotatably connected to a frame of the machine to assume said “set” and “unset” configurations.

6. The machine according to claim 5, further comprising an opposing element associated with a rotatable connection of the housing to the frame and adapted to change said housing configuration from said first “set” configuration to said second “unset” configuration.

7. The machine to claim 1, wherein said housing in said second “unset” configuration is rotated to a predetermined angle with respect to said first “set” configuration for loading the cartridge and extracting the infusion.

8. The machine according to claim 7, wherein said predetermined angle is dependent upon an angle of the machine with respect to ground upon a related end-of-stroke abutment.

9. The machine according to claim 7, wherein said predetermined angle ranges between about 40° and 180°.

10. The machine according to claim 9, wherein said predetermined angle ranges between about 45° and 90°.

11. The machine according to claim 10, wherein said predetermined angle is about 45°.

12. The machine according to claim 1, wherein the machine is configured to allow said housing to change passively by effect of gravity from said first “set” configuration to said second “unset” configuration.

13. The machine according to claim 1, wherein said moving means comprises:
a first moving means of said infusion head unit; and
a second moving means of said housing.

14. The machine according to claim 13, wherein said first moving means is a moving and opposing means connected to said infusion head unit to block said infusion head unit by opposition in a first position adjoining said housing.

15. The machine according to claim 13, wherein said first moving means is a toggle-type moving system based on a pair of hinged levers.

16. The machine according to claim 15, wherein said toggle-type moving system provides a safety blocking, by overstepping its own end of stroke in a reverse-angle configuration when said infusion head unit is in said first position adjoining said housing.

17. The machine according to claim 13, wherein said second moving means is connected to said housing and integral to said infusion head unit.

18. The machine according to claim 13, wherein said second moving means comprises at least one connecting rod, a first end of said connecting rod connected to said infusion head unit and a second end connected to said housing.

19. The machine according to claim 18, wherein said connecting rod has a slot for a sliding mechanism to be engaged with a respective element for connecting with said housing.

20. The machine according to claim 1, further comprising a locking and/or supporting means for selectively supporting and blocking said housing in said first “set” configuration.

21. The machine according to claim 20, wherein said means for blocking and/or supporting the housing is selectively actuable and/or movable by said infusion head unit.

22. The machine according to claim 20, wherein said means for blocking and/or supporting the housing further comprises:
a main bolt, having a first portion and a second portion; and
a secondary bolt, rotatably connected to the first portion of the main bolt and adapted to lock said housing.

23. The machine according to claim 22, wherein said means for blocking and/or supporting the housing comprises an elastic opposing means.

24. The machine according to claim 1, further comprising guiding means for inserting the cartridge into a cartridge holder.

25. The machine according to claim 24, wherein the overall arrangement of said guide means is dependent upon the tilt of the machine with respect to the ground to allow inserting of the cartridge into the cartridge holder by effect of gravity.

26. The machine according to claim 1, wherein the machine is mountably tilted with respect to the ground.

27. The machine according to claim 1, wherein the machine is mountably tilted 45° with respect to the ground.

28. The machine according to claim 1, wherein the machine is horizontally mountable with respect to the ground.

29. The machine according to claim 1, wherein said infusion head unit is slidably mounted with respect to a frame of the machine.
